(19) United States
(12) Patent Application Publication
(10) Pub. No.: US 2026/0192290 A1
(43) Pub. Date: Jul. 9, 2026

(54) PHOTOCATALYTIC COMPOSITE MATERIAL AND METHOD FOR MANUFACTURING THE SAME

(71) Applicants: Materials Analysis Technology Inc., Hsinchu County (TW); National Tsing Hua University, Hsinchu City (TW)

(72) Inventors: Ting-Yu Teng, Tainan City (TW); Jui-Cheng Kao, New Taipei City (TW); Hao-Wu Lin, Hsinchu County (TW); Fan-Gang Tseng, New Taipei City (TW); Li-Yu Ting, New Taipei City (TW); Ho-Hsiu Chou, Hsinchu City (TW); HUNG-JEN CHEN, Hsinchu City (TW); Yu-Chieh Lo, Hsinchu City (TW); Jyh-Pin Chou, New Taipei City (TW); Tsan-Yao Chen, Hsinchu County (TW)

(21) Appl. No.: 19/439,481

(22) Filed: Jan. 5, 2026

Related U.S. Application Data
(60) Provisional application No. 63/742,009, filed on Jan. 6, 2025.

(51) Int. Cl. B01J 31/06; B01J 23/50; B01J 23/52; B01J 35/39; B01J 35/40; B01J 35/45; B01J 37/02; B01J 37/34; C01B 3/046

(52) U.S. Cl. CPC B01J 31/06; B01J 23/50; B01J 23/52; B01J 35/39; B01J 35/40; B01J 35/45; B01J 37/0205; B01J 37/0236; B01J 37/343; C01B 3/046

(57) ABSTRACT

A photocatalytic composite material and a method for manufacturing the same. The photocatalytic composite material includes an inorganic semiconductor particle, an organic semiconductor layer, and an electron-transfer interlayer. The inorganic semiconductor particle is formed of a metal-oxide semiconductor material. The organic semiconductor layer is formed from a conjugated polymer and surrounds an outer periphery of the inorganic semiconductor particle. The electron-transfer interlayer includes a noble metal dispersed, in the forms of single atoms or nanoclusters, on a surface of the inorganic semiconductor particle, and bridges between the inorganic semiconductor particle and the organic semiconductor layer so as to form electron-transport channels.

### CROSS-REFERENCE TO RELATED PATENT APPLICATION

This application claims the benefit of priority to the U.S. Provisional Patent Application Ser. No. 63/742,009, filed on Jan. 6, 2025, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a catalytic material, and particularly to a photocatalytic composite material for hydrogen production by water splitting and a method for manufacturing the same.

### BACKGROUND OF THE DISCLOSURE

As global energy demand continues to rise, the development of clean and renewable energy sources has become an urgent necessity. Among various approaches, one potential solution is employing photocatalysts to split water and generate hydrogen. In general, after absorbing light energy, the photocatalyst material will stimulate the generation of electron-hole pairs. If the photogenerated carriers can be effectively directed to drive the water-splitting reaction, continuous hydrogen production can be achieved.

However, conventional inorganic semiconductor photocatalysts typically possess a large band gap and can only absorb ultraviolet light (which accounts for about 4% of the solar spectrum), thereby limiting light-energy utilization efficiency. Moreover, electrons and holes in inorganic semiconductors tend to recombine rapidly, resulting in low carrier-separation efficiency and poor catalytic performance in practice.

On the other hand, although recently developed organic semiconductor photocatalysts have visible-light absorption capability, these materials usually aggregate easily, which reduces light-absorption efficiency and makes carrier separation difficult. In addition, organic materials generally have low electron-injection efficiency and thus cannot effectively promote the progress of a water-splitting reaction.

Therefore, there is a need for a novel photocatalytic composite material that combines carrier-separation performance of inorganic materials with broad visible-light absorption capability of organic materials, and that solves problems of rapid carrier recombination and polymer aggregation, to improve efficiency and stability of hydrogen production by water splitting.

### SUMMARY OF THE DISCLOSURE

In response to the above-referenced technical inadequacies, the present disclosure provides a photocatalytic composite material and a method for manufacturing the same.

In order to solve the above-mentioned problems, one of the technical aspects adopted by the present disclosure is to provide a photocatalytic composite material that includes: an inorganic semiconductor particle being formed of a metal-oxide semiconductor material; an organic semiconductor layer being formed from a conjugated polymer and surrounding an outer periphery of the inorganic semiconductor particle; and an electron-transfer interlayer that includes a noble metal dispersed, in forms of a plurality of single atoms or nanoclusters, on a surface of the inorganic semiconductor particle, and that bridges between the inorganic semiconductor particle and the organic semiconductor layer so as to form electron-transport channels.

Preferably, the inorganic semiconductor particle has a conduction-band level lower than 0 V, a valence-band level higher than 1.23 V, and a band gap ranging from 2.0 eV to 3.8 eV, in which the conduction-band level and the valence-band level are measured with reference to a normal hydrogen electrode (NHE).

In one of the possible or preferred embodiments, the inorganic semiconductor particle is selected from the group consisting of titanium dioxide (TiO₂), strontium titanate (SrTiO₃), and zinc oxide (ZnO).

In one of the possible or preferred embodiments, the inorganic semiconductor particle has a particle size ranging from 5 nm to 500 nm.

In one of the possible or preferred embodiments, the organic semiconductor layer is a network film formed by interlacing a plurality of linear conjugated polymer chains, which wrap around outer peripheries of the electron-transfer interlayer and the inorganic semiconductor particle, and a portion of the surface of the inorganic semiconductor particle remains exposed.

In one of the possible or preferred embodiments, the noble metal is selected from the group consisting of gold (Au), silver (Ag), platinum (Pt), and palladium (Pd).

In one of the possible or preferred embodiments, each of the nanoclusters is a metal cluster formed of 2 to 20 metal atoms.

In one of the possible or preferred embodiments, the noble metal of the electron-transfer interlayer is present in an atomic percentage ranging from 0.5% to 15%, relative to the metal of the metal-oxide semiconductor material of the inorganic semiconductor particle.

In one of the possible or preferred embodiments, a main chain of the conjugated polymer has repeating conjugated units of fluorene and thiophene, and a dihedral angle of the conjugated polymer ranges from 0° to 5°.

In one of the possible or preferred embodiments, the organic semiconductor layer has a thickness ranging from 1 nm to 10 nm, and a surface of the photocatalytic composite material has a water contact angle ranging from 20° to 40°.

In order to solve the above-mentioned problems, another one of the technical aspects adopted by the present disclosure is to provide a method for manufacturing a photocatalytic composite material, which includes: providing an inorganic semiconductor particle as a core carrier, in which the inorganic semiconductor particle is formed of a metal-oxide semiconductor material; forming an electron-transfer interlayer including a noble metal dispersed, in forms of a plurality of single atoms or nanoclusters, on a surface of the inorganic semiconductor particle; and forming an organic semiconductor layer around outer peripheries of the inorganic semiconductor particle and the electron-transfer interlayer, in which the organic semiconductor layer is formed from a conjugated polymer, and the electron-transfer interlayer bridges between the inorganic semiconductor particle and the organic semiconductor layer to form electron-transport channels.

In one of the possible or preferred embodiments, a method for forming the electron-transfer interlayer includes: dispersing the inorganic semiconductor particle in water to form a first suspension; adding a noble metal ion-containing precursor into the first suspension; stirring the first suspension; adding a reducing agent into the first suspension to reduce the noble metal ions to single atoms or nanoclusters of noble metal; and drying the inorganic semiconductor particle with the noble metal dispersed thereon so as to form the electron-transfer interlayer.

In one of the possible or preferred embodiments, a method for forming the organic semiconductor layer includes: dispersing the inorganic semiconductor particle, whose surface is modified with the electron-transfer interlayer, into an organic solvent to form a second suspension; providing a solution of an organic semiconductor material that includes the conjugated polymer, and dropwise adding the solution of the organic semiconductor material into the second suspension under ultrasonic vibration so as to form the organic semiconductor layer.

In one of the possible or preferred embodiments, the conjugated polymer is polyfluorene-alt-3-alkylthiophene (PF3T), and a solvent that dissolves the conjugated polymer is tetrahydrofuran (THF).

Therefore, the photocatalytic composite material and the method for manufacturing the same provided by the present disclosure addresses problems that conventional inorganic semiconductors only absorb ultraviolet light and that organic semiconductors easily aggregate and have low electron-injection efficiency. The photocatalytic composite material of the present disclosure adopts the noble metal in the forms of single atoms or nanoclusters as an interlayer to bridge a conjugated polymer to an inorganic semiconductor carrier so as to avoid aggregation of the conjugated polymer. Accordingly, the photocatalytic composite material has an expanded visible-light absorption range, provides directional electron-transport paths, and suppresses rapid electron-hole recombination at an interface. As a result, the photocatalytic composite material improves a light-energy utilization rate and a hydrogen-production rate of a water-splitting reaction, while providing long-term reaction stability.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective view of a photocatalytic composite material according to an embodiment of the present disclosure;

FIG. 2 is a schematic diagram illustrating preparation process of the photocatalytic material according to the embodiment of the present disclosure;

FIG. 3 is an X-ray diffraction (XRD) pattern (scanning angles of 15° to) 20° of different samples (TiO₂, PF3T, PF3T@TiO₂, PF3T@1Au—TiO₂, and PF3T@5Au—TiO₂) according to the embodiment of the present disclosure;

FIG. 4 is an X-ray diffraction (XRD) pattern (scanning angles of 20° to) 25° of the different samples shown in FIG. 3;

FIG. 5 is an ultraviolet-visible (UV-Vis) absorption spectra in a wavelength range of 200 to 1000 nm for the different samples shown in FIG. 3;

FIG. 6 is a comparison chart of hydrogen-production rates under photocatalytic conditions for the different samples shown in FIG. 3;

FIG. 7 is an ultraviolet-visible (UV-Vis) absorption spectra for different samples (TiO₂, PF3T@TiO₂, PF3T@1Ag—TiO₂, PF3T@5Ag—TiO₂, and PF3T@50Ag—TiO₂) according to the embodiment of the present disclosure;

FIG. 8 is a comparison chart of hydrogen-production rates for the different samples shown in FIG. 7; and

FIG. 9 is a plot diagram showing a cumulative amount of hydrogen generated versus reaction time under continuous cyclic illumination for a PF3T@5Ag—TiO₂ sample.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Photocatalytic Composite Material]

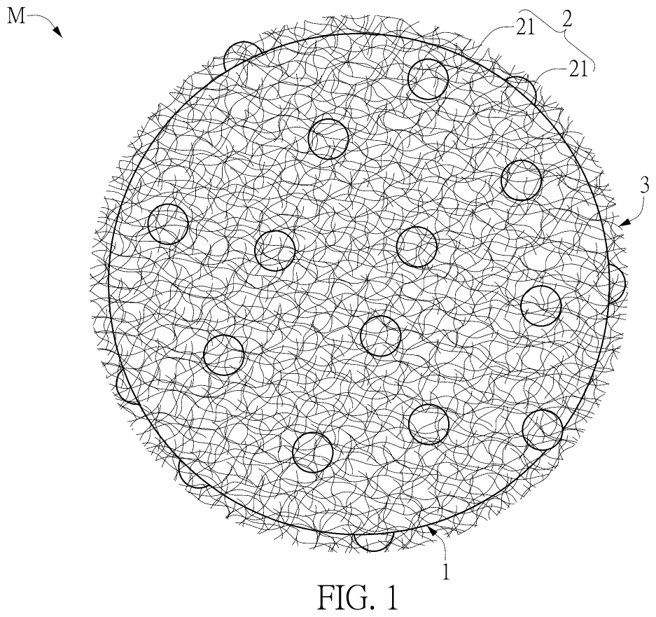

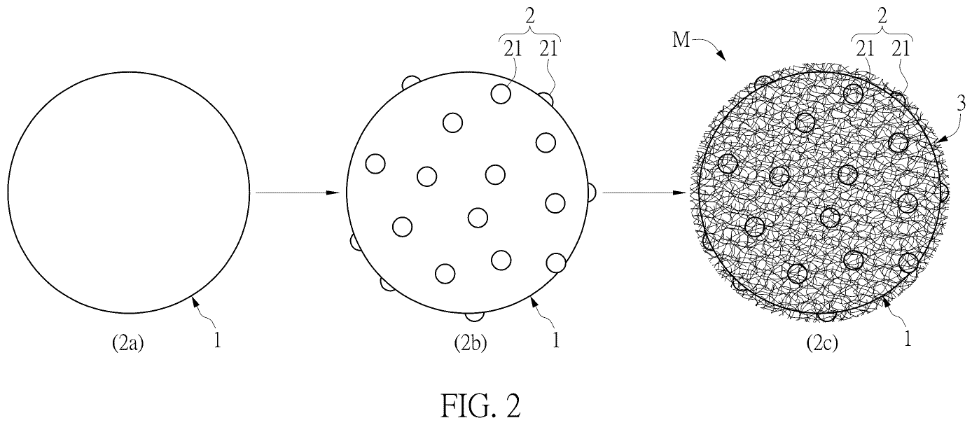

Referring to FIG. 1 and FIG. 2, an embodiment of the present disclosure provides a photocatalytic composite material M for hydrogen production by water splitting. The photocatalytic composite material M includes: an inorganic semiconductor particle(s) 1, an electron-transfer interlayer 2, and an organic semiconductor layer 3.

The inorganic semiconductor particle 1 is a particle of a metal-oxide semiconductor material and serves as a core carrier of the photocatalytic composite material M. The electron-transfer interlayer 2 includes a noble metal 21 that is dispersed on a surface of the inorganic semiconductor particle 1 in forms of a plurality of single atoms or nanoclusters, so as to form a dot-like distribution. In addition, the organic semiconductor layer 3 surrounds outer peripheries of the electron-transfer interlayer 2 and the inorganic semiconductor particle 1.

From another perspective, the electron-transfer interlayer 2 bridges between the inorganic semiconductor particle 1 and the organic semiconductor layer 3 through the noble metal 21 in the forms of the plurality of single atoms or nanoclusters, thereby forming multiple electron-transport channels with stepwise energy levels. This configuration effectively facilitates directional migration of photoexcited electrons from the organic semiconductor layer 3 to the inorganic semiconductor particle 1, and reduces the probability of electron-hole recombination.

The organic semiconductor layer 3 is formed from a conjugated polymer. More specifically, the organic semiconductor layer 3 is a network film formed by interlacing a plurality of linear conjugated polymer chains. The organic semiconductor layer 3 surrounds (wraps around) outer peripheries of the electron-transfer interlayer 2 and the inorganic semiconductor particle 1, and a portion of the surface of the inorganic semiconductor particle 1 remains exposed, so that a reaction medium (e.g., water molecules) can contact the surface of the inorganic semiconductor particle 1 and further promote carrier transport, but the present disclosure is not limited thereto.

By virtue of the above technical solution, the photocatalytic composite material M provided in the embodiment of the present disclosure addresses issues that conventional inorganic semiconductors only absorb ultraviolet light and that organic semiconductors tend to aggregate and have low electron injection efficiency.

The photocatalytic composite material M of the embodiment of the present disclosure adopts the noble metal 21 in the forms of single atoms or nanoclusters as the electron-transfer interlayer 2 to bridge the conjugated polymer (i.e., the organic semiconductor layer 3) to the inorganic semiconductor carrier (i.e., the inorganic semiconductor particle 1), thereby preventing aggregation of the conjugated polymer. Accordingly, the photocatalytic composite material M has an expanded visible-light absorption range, provides directional electron-transport paths, and suppresses rapid recombination of electrons and holes at an interface. As a result, the photocatalytic composite material M achieves improved light-energy utilization efficiency and hydrogen-production rate in the water-splitting reaction, while maintaining long-term reaction stability.

Furthermore, in terms of material selection, a conduction band (CB) level of the inorganic semiconductor particle 1 is lower than (more negative than) a reduction potential (about 0 V) for a hydrogen-production reaction in water splitting, a valence band (VB) level thereof is higher than (more positive than) an oxidation potential (about 1.23 V) for an oxidation reaction in water splitting, and a band gap (Eg) thereof ranges from about 2.0 eV to 3.8 eV.

In other words, the conduction-band level of the inorganic semiconductor particle 1 is lower than 0 V (vs. NHE), the valence-band level thereof is higher than 1.23 V (vs. NHE), and the band gap thereof ranges from 2.0 eV to 3.8 eV, so that an electron-hole pair is generated under photoexcitation and a thermodynamic driving force is provided to split water molecules into hydrogen and oxygen gases (molecules). The conduction-band level and the valence-band level are respectively obtained by Mott-Schottky measurement and UV-Vis absorption spectra, and the potentials are measured with reference to a normal hydrogen electrode (NHE).

In some embodiments of the present disclosure, the material of the inorganic semiconductor particle 1 is selected from the group consisting of titanium dioxide (TiO₂), strontium titanate (SrTiO₃), and zinc oxide (ZnO). Preferably, the inorganic semiconductor particle 1 is a titanium dioxide particle.

Furthermore, a particle size (d50) of the inorganic semiconductor particle(s) 1 ranges from 5 nm to 500 nm, preferably from 10 nm to 100 nm, and more preferably from 20 nm to 100 nm. The particle size being within the above ranges can increase a specific surface area of the particle, enlarge an interfacial area for reaction with water molecules, and facilitate migration of photogenerated carriers (electron-hole pairs) to the surface of the inorganic semiconductor particle 1 to participate in a water-splitting reaction, thereby improving photocatalytic hydrogen-production efficiency. In addition, particles with a particle size less than 100 nm have better dispersibility and light transmittance, which avoids a light-shielding effect caused by large particles. If the particle size is smaller than 5 nm, an excessively high surface energy tends to cause particle aggregation, resulting in structural instability and reduced efficiency. If the particle size is greater than 500 nm, an insufficient specific surface area reduces an effective contact area with reactants (e.g., water molecules), thereby suppressing a photoreaction rate. Moreover, a large particle size also causes nonuniform light penetration and an excessively long electron migration distance, which increases an electron-hole recombination probability and lowers hydrogen-production efficiency.

The electron-transfer interlayer 2 is formed by dispersing the noble metal 21, in the forms of a plurality of single atoms or nanoclusters, on an outer surface of the inorganic semiconductor particle 1. It should be noted that each of the nanoclusters refers to a metal cluster composed of 2 to 20 metal atoms (preferably 2 to 10, and more preferably 2 to 5). The number of atoms controlled within this range forms an ultrathin bridging layer (e.g., only one to two atomic layers in thickness), which facilitates highly efficient electron injection. Single atoms or extremely small clusters (2-5 atoms) maximize electrical conductivity, increase a probability that electrons are successfully injected into a conduction band of an inorganic semiconductor (e.g., TiO₂), and reduce a trap effect between electrons and the metal. If a metal layer is excessively thick (e.g., exceeding 5 nm, or having more than 20 atoms), electrons tend to be retained in the metal layer, causing an electron trap effect that lowers hydrogen-production efficiency, and also shielding light to affect an overall photoenergy conversion efficiency.

In some embodiments of the present disclosure, the noble metal is selected from the group consisting of gold (Au), silver (Ag), platinum (Pt), and palladium (Pd). Preferably, the noble metal is selected from at least one of gold and silver.

In some embodiments of the present disclosure, an atomic percentage of the noble metal in the electron-transfer interlayer 2, relative to the metal of the metal-oxide semiconductor material of the inorganic semiconductor particle 1, ranges from 0.5% to 15%, preferably from 1% to 10%, and more preferably from 1% to 7%.

The electron-transfer interlayer 2 possesses high electrical conductivity and chemical stability, which enhances electron-transport efficiency and extends carrier lifetime. Through the catalytic activity thereof, the electron-transfer interlayer 2 also strengthens light absorption and improves the efficiency of the hydrogen-production reaction, thereby effectively suppressing electron-hole recombination.

The organic semiconductor layer 3 is formed from a conjugated polymer. The main chain of the conjugated polymer contains repeating conjugated units of fluorene and thiophene, which effectively absorb energy within the visible-light range and promote the generation of photogenerated carriers. Furthermore, a dihedral angle between adjacent conjugated units on the main chain of the conjugated polymer ranges from about 0° to 5°, and preferably from 0° to 2°. The dihedral angle can be determined through density functional theory (DFT) calculations.

A smaller dihedral angle enhances the resonance capability of the polymer, resulting in a red-shift in the absorption spectrum and stronger absorption in the visible-light region, while also increasing electron carrier mobility and improving electron-transport efficiency.

Preferably, the conjugated polymer is a polyfluorene-thiophene derivative, such as a polyfluorene-alt-3-alkylthiophene (PF3T) conjugated polymer. PF3T exhibits excellent visible-light absorption capability, with an absorption range covering wavelengths of approximately 400 nm to 600 nm. The organic semiconductor layer 3 has a thickness ranging from 1 nm to 10 nm, and preferably from 1 nm to 5 nm. Controlling the thickness within the above-mentioned ranges provides a good balance among light-absorption efficiency, electron-injection capability, and water permeability of the material. When the thickness is below the lower limit, the interfacial electron-injection efficiency decreases, thereby affecting overall catalytic stability. Conversely, when the thickness exceeds the upper limit, the longer electron-migration distance increases carrier recombination probability and hinders water molecules from contacting the surface of the inorganic semiconductor particle 1, thereby reducing hydrogen-production efficiency.

The surface of the photocatalytic composite material M has a water contact angle (WCA) of about 20° to 40°, indicating moderate hydrophilicity that facilitates the contact and adsorption of reactants (e.g., water molecules), thereby enhancing both the progress and efficiency of the photocatalytic hydrogen-production reaction.

### [Method for Manufacturing Photocatalytic Composite Material]

Referring to FIG. 2, another embodiment of the present disclosure provides a method for manufacturing a photocatalytic composite material, which includes step S110, step S120, and step S130.

Referring to FIG. 2 (2a), step S110 includes: providing an inorganic semiconductor particle(s) 1 as a core carrier. The inorganic semiconductor particle 1 is a particle of a metal-oxide semiconductor material, such as titanium dioxide (TiO₂), strontium titanate (SrTiO₃), or zinc oxide (ZnO).

Referring to FIG. 2 (2b), step S120 includes: forming an electron-transfer interlayer 2 on a surface of the inorganic semiconductor particle 1.

The method for forming the electron-transfer interlayer 2 includes: dispersing the inorganic semiconductor particle 1 in water (e.g., deionized water) to form a first suspension; adding a precursor containing noble-metal ions (e.g., HAuCl₄ or AgNO₃) into the first suspension and stirring to allow the noble-metal ions to be uniformly adsorbed onto the surface of the inorganic semiconductor particle(s) 1; subsequently adding a reducing agent (e.g., sodium borohydride, NaBH₄) to reduce the noble-metal ions on the surface of the inorganic semiconductor particle 1 into a noble metal 21 in the forms of single atoms or nanoclusters under room-temperature conditions; and then performing centrifugation, washing, and drying to obtain a composite powder in which the surface of the inorganic semiconductor particle 1 is modified with the electron-transfer interlayer 2 (e.g., TiO₂—Au powder or TiO₂—Ag powder).

Referring to FIG. 2 (2c), step S130 includes: forming an organic semiconductor layer 3 around an outer periphery of the composite powder.

The method for forming the organic semiconductor layer 3 includes: dispersing the composite powder in an organic solvent (e.g., methanol) to form a second suspension; separately preparing a solution of an organic semiconductor material (e.g., a linear conjugated polymer PF3T) using tetrahydrofuran (THF) as a solvent; and slowly adding the organic semiconductor solution dropwise into the second suspension under ultrasonic vibration to ensure thorough mixing. Through this process, the organic semiconductor layer 3 is formed, wrapping around the outer periphery of the inorganic semiconductor particle 1 and the electron-transfer interlayer 2 (e.g., as a network film formed by interlacing multiple linear conjugated polymer chains). Subsequently, centrifugation and washing are performed, followed by low-temperature drying, to obtain the photocatalytic composite material M.

Specifically, dispersing the composite powder in a polar organic solvent (e.g., methanol) helps maintain a stable suspension state of the composite powder and prevents particle aggregation. At the same time, dissolving the organic semiconductor material (e.g., a linear conjugated polymer) in an organic solvent with polymer solubility (e.g., tetrahydrofuran) improves the extension of polymer chains and enhances solution stability. By slowly adding the organic semiconductor solution dropwise into the above suspension, the mutual compatibility between methanol and tetrahydrofuran facilitates uniform wrapping of the linear conjugated polymer chains around the outer surfaces of the inorganic particles and metal nanoclusters.

In some embodiments of the present disclosure, the noble metal 21 of the electron-transfer interlayer 2 is selected from noble-metal materials, such as gold (Au), silver (Ag), platinum (Pt), or palladium (Pd). An atomic ratio between the noble metal and a metal element of the inorganic semiconductor particle 1 (the metal-oxide semiconductor material) is controlled by adjusting the concentration of the precursor, with an atomic percentage ranging from 0.5% to 15%, to optimize electron-transport efficiency and photocatalytic performance. In addition, the thickness of the organic semiconductor layer 3 can be adjusted by controlling the polymer concentration and dropwise addition rate, and preferably ranges from 1 nm to 10 nm, thereby effectively broadening the visible-light absorption range, enhancing carrier migration efficiency, and improving both the efficiency and long-term stability of photocatalytic hydrogen production by water splitting.

### [Preparation of PF3T@Au—TiO₂].

The following describes a method for preparing PF3T@Au—TiO₂ according to a specific embodiment of a photocatalytic composite material of the present disclosure.

First, titanium dioxide (TiO₂) particles are provided as the inorganic semiconductor core material, and the titanium dioxide particles are dispersed in deionized water to form a first suspension that is uniformly mixed. Next, a chloroauric acid (HAuCl₄) metal precursor solution is added into the first suspension and stirred at room temperature (about 25° C.) at about 500 rpm for 2 hours, allowing Au ions to be uniformly adsorbed onto the surfaces of the titanium dioxide particles. Subsequently, sodium borohydride (NaBH₄) is added as a reducing agent to reduce the Au ions into gold (Au) in the forms of single atoms or nanoclusters under room-temperature conditions, thereby forming Au—TiO₂ composite powders. The resulting Au—TiO₂ composite powders are washed with ethanol and deionized water, separated by centrifugation three times, and then dried at 60° C. to obtain gold-modified titanium dioxide (Au—TiO₂) powders.

Subsequently, the prepared Au—TiO₂ powders are dispersed in methanol (MeOH) to form a second suspension that is uniformly mixed. Meanwhile, a linear conjugated polymer PF3T is dissolved in tetrahydrofuran (THF) to prepare a polymer solution. Under ultrasonic vibration and stirring at about 700 rpm, the PF3T polymer solution is added dropwise into the second suspension (Au—TiO₂ suspension), and stirring is continued for 16 hours, allowing PF3T to form a uniform organic semiconductor layer on the surfaces of the composite powders.

Finally, the resulting mixture is washed with ethanol (EtOH) and separated by centrifugation twice, followed by drying at 60° C. to obtain the final photocatalytic composite material, PF3T@Au—TiO₂.

### [Experimental Results of PF3T@Au—TiO₂].

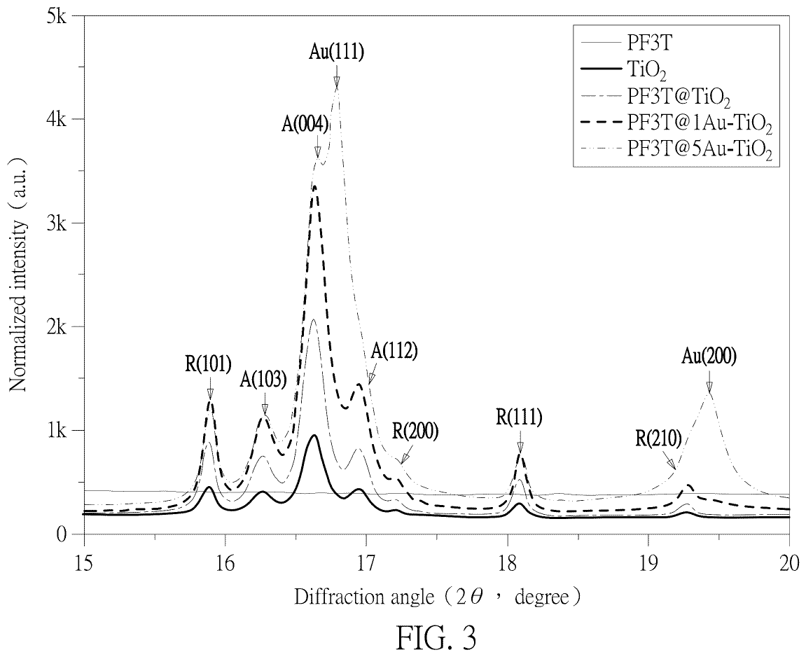

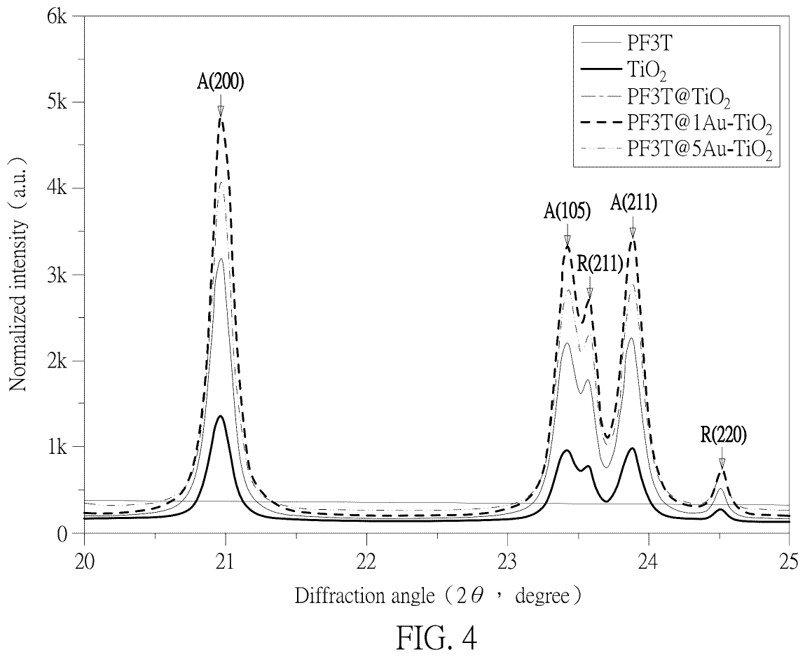

Referring to FIG. 3 and FIG. 4, FIG. 3 illustrates the X-ray diffraction (XRD) pattern of the PF3T@Au—TiO₂ composite material of the embodiment of the present disclosure, recorded at scanning angles of 15° to 20°. FIG. 4 illustrates another XRD pattern of the same PF3T@Au—TiO₂ composite material, recorded at scanning angles of 20° to 25°.

In the PF3T@Au—TiO₂ material of the embodiment of the present disclosure, the TiO₂ crystals exhibit a coexistence of anatase (A) phase and rutile (R) phase. Distinct diffraction peaks corresponding to Au (111) and Au (200) are observed at approximately 16.8° and 19.5° (20) in the PF3T@1Au—TiO₂ and PF3T@5Au—TiO₂ samples, respectively, clearly confirming that gold (Au) has been successfully modified on the surfaces of the TiO₂ particles.

Further analysis reveals that the intensity of the Au characteristic peaks in the PF3T@5Au—TiO₂ sample is higher than that in the PF3T@1Au—TiO₂ sample, indicating that increasing the gold content leads to a larger size or higher density of Au nanoclusters.

It should be noted that “1Au” and “5Au” in this context refer to the atomic ratio (atomic percentage) of the added gold (Au) precursor relative to the metal atoms (Ti) in the inorganic semiconductor particles (e.g., TiO₂), corresponding to approximately 1% (1Au) and 5% (5Au), respectively. In other words, during the preparation of the electron-transfer interlayer 2, the atomic ratio of gold atoms to titanium atoms is about 1:100 in “1Au—TiO₂” and about 5:100 in “5Au—TiO₂.” These ratios correspond to the metal loading amounts defined in the experimental design and serve as key parameters for controlling nanocluster size, which in turn influence the material's structure, electron-transport efficiency, and photocatalytic performance.

According to the test results of the water contact angle (WCA) (figures not shown), the surface of pure PF3T exhibits hydrophobic behavior (WCA being about) 98.0°, whereas pure TiO₂ is highly hydrophilic (WCA being less than) 10°. After PF3T is combined with TiO₂ to form PF3T@TiO₂, the WCA decreases to approximately 21.5°, indicating enhanced surface hydrophilicity. Upon further modification with Au nanoclusters at gold atomic percentages of 1% and 5%, the contact angles are approximately 31.8° (1Au) and 34.5° (5Au), respectively, showing a slight increase while remaining within the range of moderate hydrophilicity. These results demonstrate that the hydrophilicity of the material can be effectively tuned by adjusting its surface composition, thereby facilitating water-molecule contact and improving interfacial efficiency of the photocatalytic reaction.

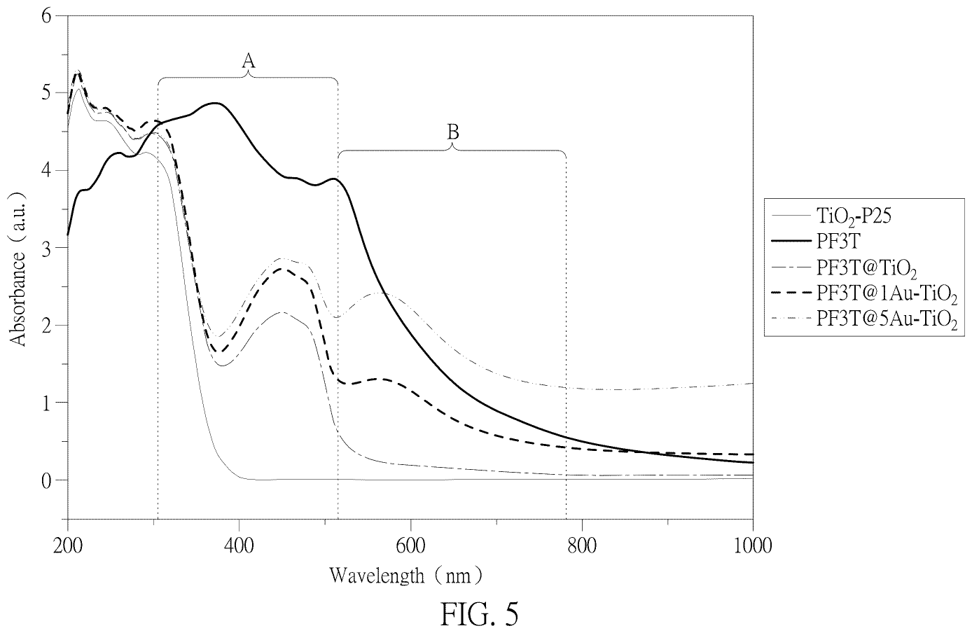

FIG. 5 presents ultraviolet-visible (UV-Vis) absorption spectra in the wavelength range of 200 to 1000 nm for various samples (TiO₂—P25, PF3T, PF3T@TiO₂, PF3T@1Au—TiO₂, and PF3T@5Au—TiO₂) to compare their light-absorption capacities and spectral ranges.

As shown in FIG. 5, TiO₂ exhibits significant absorption only in the ultraviolet region (being less than 400 nm), indicating that its photo-response is confined to the UV range. In contrast, the PF3T material alone displays broad visible-light absorption (region A, approximately 350-600 nm).

When PF3T is combined with TiO₂ to form PF3T@TiO₂, the resulting absorption spectrum reflects the combined characteristics of both materials, showing enhanced absorption in the visible region.

Upon further modification with gold atoms or gold nanoclusters, the PF3T@1Au—TiO₂ and PF3T@5Au—TiO₂ samples exhibit distinct additional absorption enhancement in the range of 500 to 800 nm (region B), which corresponds to the surface plasmon resonance (SPR) effect of the metallic nanoparticles. In particular, the 5Au sample demonstrates the strongest absorption in the near-infrared region, indicating that it further broadens the absorption range and enhances visible-light photocatalytic performance. These findings confirm that the heterogeneous composite structure of the embodiment of the present disclosure effectively extends the light-absorption spectrum and improves light-energy utilization through the synergistic interaction between the organic polymer and the metal nanoclusters.

In tests that are not shown in the figures, time-resolved photoluminescence (TRPL) spectra of different samples (PF3T, PF3T@TiO₂, PF3T@1Au—TiO₂, and PF3T@5Au—TiO₂) were analyzed to evaluate variations in carrier lifetimes among the different samples. The experimental results reveal that PF3T exhibits the fastest fluorescence decay rate, indicating a high recombination rate of electrons and holes and, consequently, a short carrier lifetime. When PF3T is combined with TiO₂ to form PF3T@TiO₂, the carrier lifetime is notably extended, demonstrating that the interfacial structure facilitates electron injection into TiO₂ and suppresses rapid recombination.

After further modifying gold atoms or nanoclusters at the interface between PF3T and TiO₂ (e.g., PF3T@1Au—TiO₂ and PF3T@5Au—TiO₂), the fluorescence decay becomes slower. Among these samples, PF3T@1Au—TiO₂ exhibits the best performance, with its carrier lifetime extended to approximately 20 ns. This result indicates that the intermediate energy levels formed by the noble-metal nanoclusters effectively suppress electron-hole recombination and promote directional electron transport.

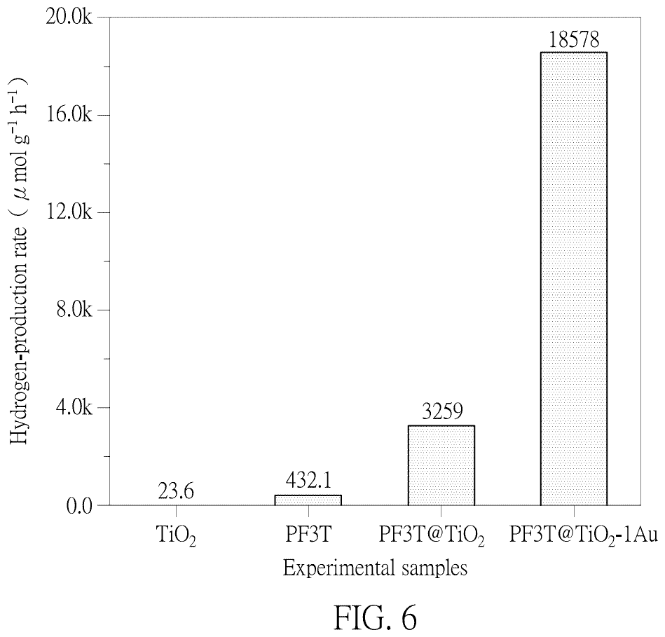

FIG. 6 shows a comparison chart of hydrogen-production rates (umol·g⁻¹·h⁻¹) under photocatalytic conditions for different samples, including pure PF3T, TiO₂, PF3T@TiO₂, and the PF3T@TiO₂-1Au composite material.

The experimental results reveal that, when TiO₂ or PF3T is used individually, their photocatalytic hydrogen-production efficiencies are relatively low, approximately 23.6 and 432.1 μmol·g⁻¹·h⁻¹, respectively, indicating that either material alone lacks a sufficient light-absorption range or carrier-separation efficiency. When TiO₂ and PF3T are combined to form a heterostructure (PF3T@TiO₂), the hydrogen-production rate significantly increases to 3,259 μmol·g⁻¹·h⁻¹.

By further introducing gold atoms or gold nanoclusters as an electron-transfer bridging layer (PF3T@TiO₂-1Au), the hydrogen-production efficiency increases markedly to 18,578 μmol·g⁻¹·h⁻¹, which is nearly 800 times higher than that of TiO₂ alone. This result demonstrates that gold modification effectively enhances photocatalytic performance by providing an energy-level bridge for electron transfer. Accordingly, the findings confirm that the material design of the present disclosure significantly improves hydrogen production efficiency in water-splitting reactions.

It should be noted that the above hydrogen-production rates are measured, for example, under simulated sunlight irradiation during photocatalytic water-splitting experiments. Specifically, a fixed amount of photocatalyst powder (e.g., 20 mg) is dispersed in a fixed volume of reaction solution (e.g., 100 mL of deionized water) and uniformly suspended by magnetic stirring in a sealed quartz reactor. The light source adopts an AM 1.5G simulated sunlight illumination system with a total light intensity of 100 mW/cm2, and the reaction temperature is maintained at room temperature (approximately 25° C.). Under continuous illumination, gas samples are collected at fixed time intervals (e.g., every 30 minutes) using a gas-collection system (e.g., a gas-collection bottle or a microreactor), and the hydrogen concentration in the collected gas is analyzed by gas chromatography (GC). The hydrogen-production rate (HER, μmol·g⁻¹·h⁻¹) is calculated based on the number of micromoles (μmol) of hydrogen generated per unit mass of catalyst (g) per unit time (h) and serves as a comparative index of photocatalytic efficiency among the samples, but the present disclosure is not limited thereto.

Overall, the prepared photocatalytic composite material exhibits high visible-light absorption efficiency and excellent electron-conduction characteristics, effectively enhancing both the performance and stability of photocatalytic hydrogen production through water splitting.

### [Preparation of PF3T@Ag—TiO₂].

First, titanium dioxide (TiO₂) particles are provided as the inorganic semiconductor core material, and the titanium dioxide particles are dispersed in deionized water to form a first suspension that is uniformly mixed. Next, a silver nitrate (AgNO₃) metal precursor solution is added into the first suspension and continuously stirred at about 400 rpm for approximately 4 hours under room-temperature conditions, allowing Ag ions to be uniformly adsorbed onto the surfaces of the titanium dioxide particles. Subsequently, sodium borohydride (NaBH₄) is added as a reducing agent to reduce the Ag ions into silver (Ag) in the forms of single atoms or nanoclusters under room-temperature conditions. The resulting Ag—TiO₂ composite powders are then separated by centrifugation and washed three times to remove excess impurities, followed by drying at 130° C. to obtain purified Ag—TiO₂ composite powders.

Subsequently, the prepared Ag—TiO₂ composite powders are dispersed in methanol (MeOH) to form a second suspension that is uniformly mixed. Meanwhile, a linear conjugated polymer PF3T is dissolved in tetrahydrofuran (THF) to prepare a polymer solution. Under ultrasonic vibration and stirring at about 700 rpm, the PF3T polymer solution is added dropwise into the second suspension (Ag—TiO₂ suspension), and stirring is continued for 16 hours, allowing PF3T to form a uniform organic semiconductor layer on the surfaces of the composite powders.

Finally, the resulting mixture is washed with ethanol (EtOH) and separated by centrifugation twice, followed by drying at 60° C. to obtain the final photocatalytic composite material, PF3T@Ag—TiO₂.

### [Experimental Results of PF3T@Ag—TiO₂].

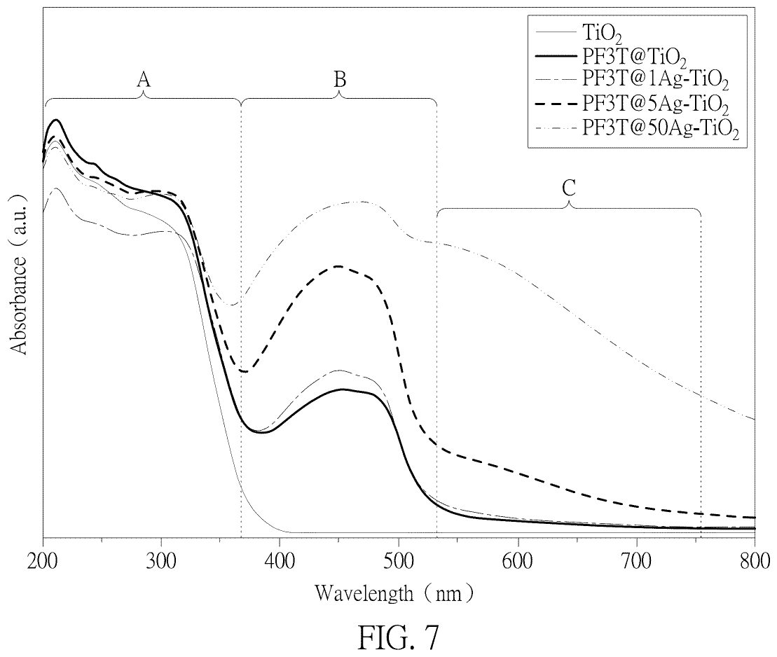

FIG. 7 presents ultraviolet-visible (UV-Vis) absorption spectra in the wavelength range of 200 to 800 nm for various samples (TiO₂, PF3T@TiO₂, PF3T@1Ag—TiO₂, PF3T@5Ag—TiO₂, and PF3T@50Ag—TiO₂), which are used to analyze the effects of silver modification and polymer coating on the light-absorption characteristics of the materials.

The experimental results indicate that TiO₂ exhibits significant absorption only in the ultraviolet region (region A, being less than 400 nm), suggesting a limited photo-response range. In contrast, the PF3T@TiO₂ sample shows absorption extending into the visible-light region (region B), demonstrating that polymer coating effectively broadens the absorption band. After introducing silver modification (PF3T@1Ag—TiO₂ and PF3T@5Ag—TiO₂), absorption in the range of approximately 400 to 600 nm is further enhanced.

In the long-wavelength region (region C, 600 to 800 nm), PF3T@50Ag—TiO₂ exhibits the strongest absorption, indicating that a high silver content further extends the light-absorption range. However, excessive silver loading may lead to light-shielding effects and carrier recombination; therefore, subsequent comprehensive evaluation in combination with hydrogen-production efficiency is required.

In tests that are not shown in figures, time-resolved photoluminescence (TRPL) spectra of different samples (TiO₂, PF3T, PF3T@TiO₂, PF3T@1Ag—TiO₂, PF3T@5Ag—TiO₂, and PF3T@50Ag—TiO₂) were analyzed to evaluate carrier lifetimes. The TiO₂ and PF3T samples display the fastest TRPL decay, indicating rapid recombination of photogenerated electrons and holes and thus short carrier lifetimes. When the two materials are combined to form PF3T@TiO₂, the fluorescence lifetime is significantly prolonged, suggesting that the heterogeneous interface facilitates electron injection and separation. After introducing silver modification, the TRPL curves of PF3T@1Ag—TiO₂ and PF3T@5Ag—TiO₂ become noticeably flatter, indicating that the intermediate energy levels formed by the silver nanoclusters effectively extend the carrier lifetime to approximately 10 ns. Although PF3T@50Ag—TiO₂ still exhibits delayed luminescence, the carrier lifetime thereof is slightly shorter, likely due to the formation of nonradiative recombination centers caused by densely packed silver clusters, which reduce carrier-separation efficiency.

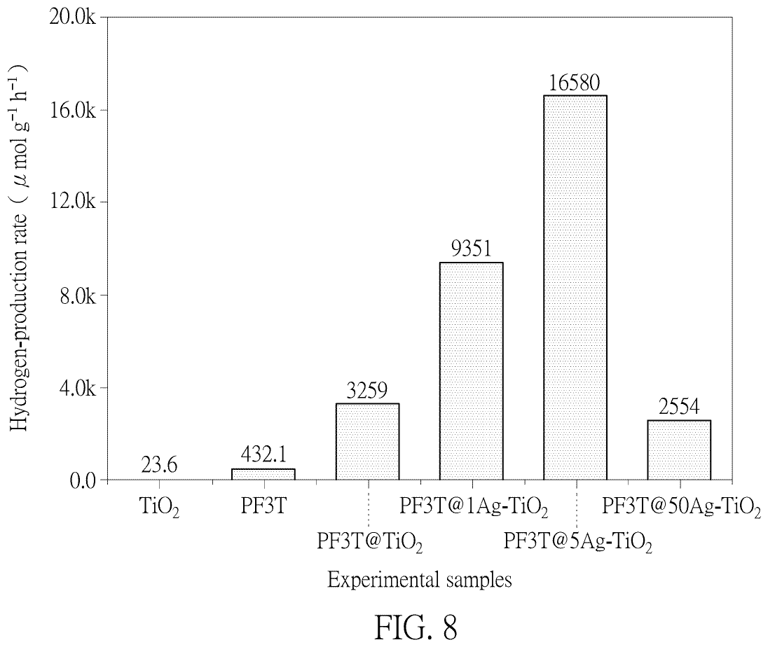

FIG. 8 shows a comparison chart of hydrogen-production rates (μmol·g⁻¹·h⁻¹) under photocatalytic water-splitting conditions for various samples, including TiO₂, PF3T, PF3T@TiO₂, PF3T@1Ag—TiO₂, PF3T@5Ag—TiO₂, and PF3T@50Ag—TiO₂.

The experimental results indicate that when TiO₂ or PF3T is used alone, the photocatalytic hydrogen-production efficiencies are low (e.g., 23.6 μmol·g⁻¹·h⁻¹ for TiO₂ and 432.1 μmol·g⁻¹·h⁻¹ for PF3T). After combining the two materials to form a heterostructure (PF3T@TiO₂), the hydrogen-production rate increases significantly to 3,259 μmol·g⁻¹·h⁻¹.

When different amounts of Ag nanoclusters are further introduced at the heterogeneous interface, a noticeable variation in efficiency is observed. The hydrogen-production rates of PF3T@1Ag—TiO₂ and PF3T@5Ag—TiO₂ reach 9,351 and 16,580 μmol·g⁻¹·h⁻¹, respectively, demonstrating that the silver clusters act as electron-bridging structures that improve both electron-migration efficiency and visible-light absorption capability. Among them, the 5Ag sample exhibits the best performance.

However, under excessive loading conditions (PF3T@50Ag—TiO₂), the hydrogen-production efficiency drops to 2,554 μmol·g⁻¹·h⁻¹, which is likely caused by over-aggregation of silver clusters, resulting in surface light shielding and an increased electron-hole recombination rate. Overall, the results confirm that optimizing the noble-metal loading amount and interfacial design can effectively enhance water-splitting efficiency, and that an optimal noble-metal loading range (e.g., 5%) achieves the best catalytic performance.

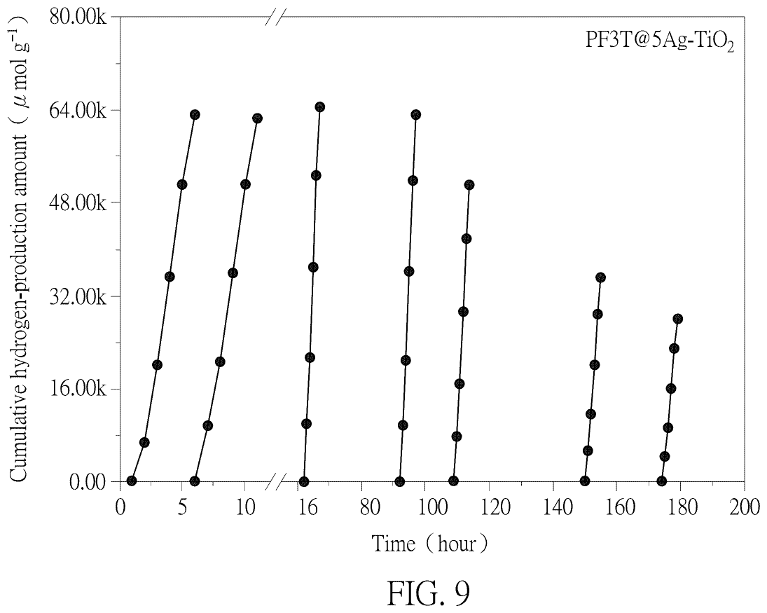

FIG. 9 illustrates the variation in cumulative hydrogen generation (μmol·g⁻¹) over different reaction times for the PF3T@5Ag—TiO₂ sample under continuous cyclic illumination, to evaluate its long-term photocatalytic stability.

The results show that, under simulated sunlight irradiation and after extended cyclic testing, the PF3T@5Ag—TiO₂ sample continues to exhibit stable and efficient photocatalytic hydrogen-production behavior. During each reaction cycle, the sample consistently generates hydrogen, demonstrating that the photocatalytic efficiency of the sample remains nearly unchanged with increasing reaction time. Although slight decreases in hydrogen-production rate are observed during the 6th and 7th cycles, the overall catalytic activity remains high, confirming that the material maintains structural stability and that the electron-transport and light-absorption properties thereof do not significantly degrade under prolonged illumination.

### Beneficial Effects of the Embodiments

In summary, the photocatalytic composite material provided in the embodiment of the present disclosure addresses problems that conventional inorganic semiconductors only absorb ultraviolet light and that organic semiconductors easily aggregate and have low electron-injection efficiency.

The photocatalytic composite material of the embodiment of the present disclosure adopts the noble metal in forms of single atoms or nanoclusters as an interlayer to bridge a conjugated polymer to an inorganic semiconductor carrier so as to avoid aggregation of the conjugated polymer. Accordingly, the photocatalytic composite material broadens a visible-light absorption range, provides directional electron-transport paths, and suppresses rapid electron-hole recombination at an interface. As a result, the photocatalytic composite material increases a light-energy utilization rate and a hydrogen-rate of a water-splitting reaction, and also provides long-term reaction stability.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A photocatalytic composite material, comprising:
an inorganic semiconductor particle formed of a metal-oxide semiconductor material;
an organic semiconductor layer formed of a conjugated polymer and surrounding an outer periphery of the inorganic semiconductor particle; and
an electron-transfer interlayer that includes a noble metal dispersed, in forms of a plurality of single atoms or nanoclusters, on a surface of the inorganic semiconductor particle, and that bridges between the inorganic semiconductor particle and the organic semiconductor layer so as to form electron-transport channels.

2. The photocatalytic composite material according to claim 1, wherein the inorganic semiconductor particle has a conduction-band level lower than 0 V, a valence-band level higher than 1.23 V, and a band gap ranging from 2.0 eV to 3.8 eV, and wherein the conduction-band level and the valence-band level are measured with reference to a normal hydrogen electrode (NHE).

3. The photocatalytic composite material according to claim 1, wherein the inorganic semiconductor particle is selected from the group consisting of titanium dioxide (TiO₂), strontium titanate (SrTiO₃), and zinc oxide (ZnO).

4. The photocatalytic composite material according to claim 1, wherein the inorganic semiconductor particle has a particle size ranging from 5 nm to 500 nm.

5. The photocatalytic composite material according to claim 1, wherein the organic semiconductor layer is a network film formed by interlacing a plurality of linear conjugated polymer chains, and wherein the organic semiconductor layer wraps around outer peripheries of the electron-transfer interlayer and the inorganic semiconductor particle, and a portion of the surface of the inorganic semiconductor particle remains exposed.

6. The photocatalytic composite material according to claim 1, wherein the noble metal is selected from the group consisting of gold (Au), silver (Ag), platinum (Pt), and palladium (Pd).

7. The photocatalytic composite material according to claim 1, wherein each of the nanoclusters is a metal cluster formed of 2 to 20 metal atoms.

8. The photocatalytic composite material according to claim 1, wherein the noble metal of the electron-transfer interlayer is present in an atomic percentage ranging from 0.5% to 15%, relative to the metal of the metal-oxide semiconductor material of the inorganic semiconductor particle.

9. The photocatalytic composite material according to claim 1, wherein a main chain of the conjugated polymer has repeating conjugated units of fluorene and thiophene, and wherein a dihedral angle of the conjugated polymer ranges from 0° to 5°.

10. The photocatalytic composite material according to claim 1, wherein the organic semiconductor layer has a thickness ranging from 1 nm to 10 nm, and a surface of the photocatalytic composite material has a water contact angle ranging from 20° to 40°.

11. A method for manufacturing a photocatalytic composite material, comprising:
providing an inorganic semiconductor particle as a core carrier, wherein the inorganic semiconductor particle is formed of a metal-oxide semiconductor material;
forming an electron-transfer interlayer including a noble metal dispersed, in forms of a plurality of single atoms or nanoclusters, on a surface of the inorganic semiconductor particle; and
forming an organic semiconductor layer around outer peripheries of the inorganic semiconductor particle and the electron-transfer interlayer, wherein the organic semiconductor layer is formed from a conjugated polymer, and the electron-transfer interlayer bridges between the inorganic semiconductor particle and the organic semiconductor layer to form electron-transport channels.

12. The method according to claim 11, wherein a method for forming the electron-transfer interlayer comprises:
dispersing the inorganic semiconductor particle in water to form a first suspension; adding a noble metal ion-containing precursor into the first suspension; stirring the first suspension; adding a reducing agent into the first suspension to reduce the noble metal ions to single atoms or nanoclusters of noble metal; and drying the inorganic semiconductor particle with the noble metal dispersed thereon so as to form the electron-transfer interlayer.

13. The method according to claim 12, wherein a method for forming the organic semiconductor layer comprises:
dispersing the inorganic semiconductor particle, whose surface is modified with the electron-transfer interlayer, into an organic solvent to form a second suspension; providing a solution of an organic semiconductor material that includes the conjugated polymer, and dropwise adding the solution of the organic semiconductor material into the second suspension under ultrasonic vibration so as to form the organic semiconductor layer.

14. The method according to claim 13, wherein the conjugated polymer is polyfluorene-alt-3-alkylthiophene (PF3T), and a solvent that dissolves the conjugated polymer is tetrahydrofuran (THF).
